(19) United States
(12) Patent Application Publication
(10) Pub. No.: US 2009/0102736 A1
(43) Pub. Date: Apr. 23, 2009

(54) Monopole antenna

(76) Inventors: Philippe Minard, Saint Medard Sur Ille (FR); Ali Louzir, Rennes (FR); Jean-Francois Pintos, Bourgbarre (FR); Jean-Luc Robert, Betton (FR)

Correspondence Address: Robert D. Shedd;Thomson Licensing LLC, PO Box 5312, PRINCETON, NJ, 08543-5312, US

(21) Appl. No.: 11/920,826

(22) PCT Filed: May 24, 2006
(86) PCT No.: PCT/FR2006/001203

§ 371 Date: Nov. 20, 2007

(30) Foreign Application Priority Data
May 27, 2005 (FR) 0551395

(51) Int. Cl. H01Q 9/32

(52) U.S. Cl. 343/825

(57) ABSTRACT

The invention relates to a monopole antenna with a radiating element mounted onto a base by means of a mast, of which the radiating element is formed from two conductive strands, in U, the length L of each strand being chosen such that ¼ λg≦L≦½ λg, λg being the wavelength in a strand at a central radiation frequency F0.

This invention relates to a monopole antenna, and more particularly a low cost compact antenna with wide frequency band covering the entire UHF band. This invention also relates to a monopole antenna suitable to portable receive terrestrial digital television (TNT) and that does not require an impedance matching network.

With antennas, a compromise must be found between the wish to reduce the maximum size and volume taken up by an antenna, and on the other hand, the need to maintain minimum antenna dimensions to ensure efficient radiation and/or the bandwidth required for this antenna. Indeed, the dimensions of the antenna are imposed by the laws of physics and for low frequency applications, it is very difficult to reduce the size of the antenna while conserving interesting performance in terms of frequency bandwidth and yield.

On the other hand, with regards to terrestrial digital television, the modulation used is an OFDM multi-carrier modulation compliant with the DVB-T (Digital Video Broadcast Terrestrial) standard. This OFDM modulation is particularly robust, particularly to multi-path incidents. However there are reception problems with regards to portable reception as the signal transmitted is a digital signal which is different from an analogue signal of which the degradation is progressive. The degradation of a digital signal from a quality reception to a total loss of picture takes place quickly.

Therefore the aim of this invention is to provide a small sized, monopole antenna with low production costs and satisfactory performance levels, notably in terrestrial digital television.

This invention relates to a monopole antenna with a radiating element mounted onto a base by means of a mast, characterized in that the radiating element is formed from two conductive U strands, the length L of each strand being chosen such that ¼λg≦L≦½λg, λg being the wavelength in a strand at a central radiation frequency F0.

This shape of monopole antenna makes it possible to use less material and thus produce a lighter antenna. On the other hand, it is possible to design monopole antennas whose radiating element has a low thickness. This means it can be produced at a low cost, notably by using sheet metal stamping techniques.

According to another characteristic of this invention, the monopole antenna strands have a profile which correspond to a specific folding. The strands are thus folded according to an L-shaped profile, a crenellate profile or also a polygonal or sinusoidal profile.

Preferably, the conductive strands are made from metal or metallized material. Likewise, the base supporting the radiating elements by means of a mast comprise a plane made from metal or metallized material forming a ground plane for the radiating element. Preferably, the metal plane forming a ground plane has dimensions between ⅕·λg and 1/10·λg of the wavelength at the central radiation frequency.

Other characteristics and advantages of the present invention will emerge upon reading the description of different embodiments given as non-restrictive examples, the description being made with reference to the figures attached wherein:

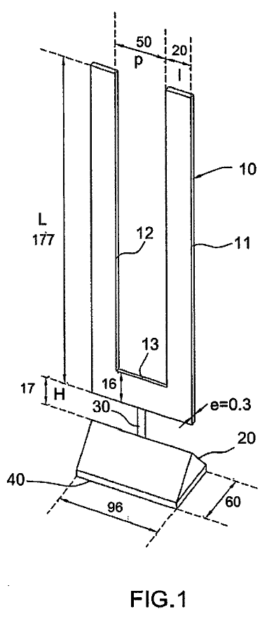

FIG. 1 is a diagrammatic perspective view of an antenna in accordance with this invention.

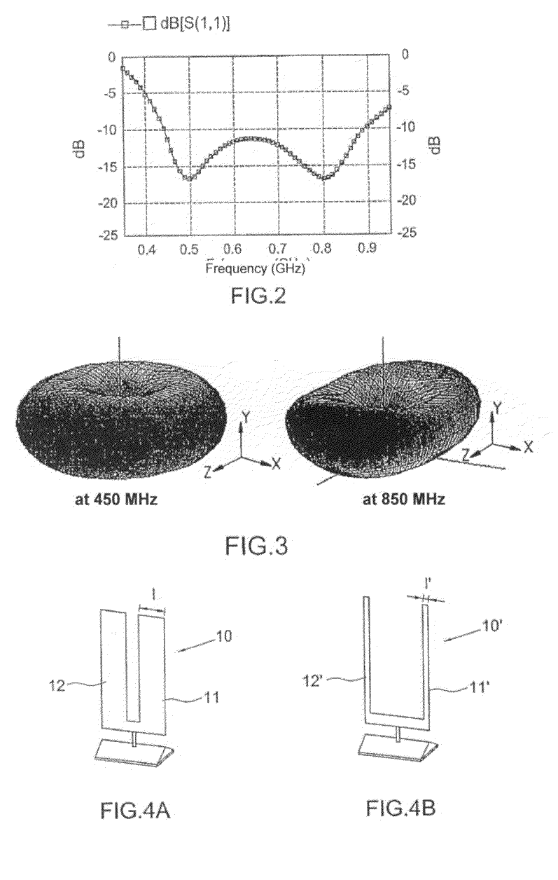

FIG. 2 is a diagram indicating the impedance matching S(1,1) according to the frequency for the antenna in FIG. 1.

FIG. 3 diagrammatically shows the radiation patterns at 450 MHz and 850 MHz obtained by simulating the antenna of FIG. 1.

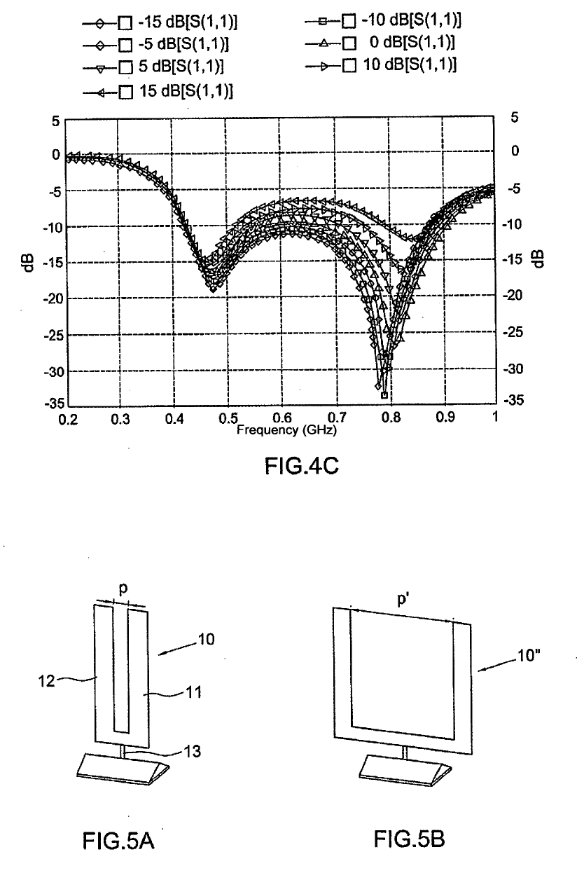

FIGS. 4A, 4B and 4C respectively show an antenna compliant with the antenna in FIG. 1 but with different strand widths as well as the pattern indicating the impedance according to the frequency for different strand widths.

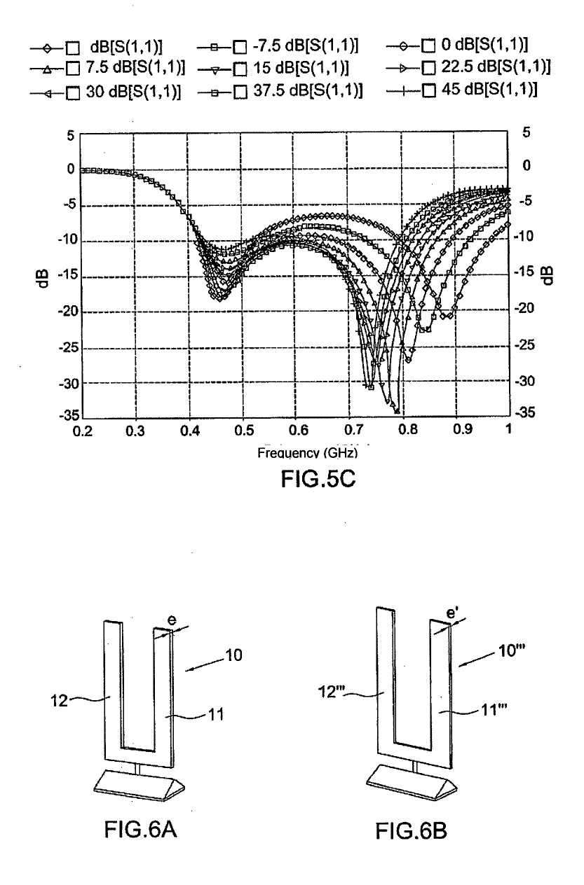

FIGS. 5A, 5B and 4C respectively show an antenna in accordance with the antenna in FIG. 1 but with a spacing between the two variable strands as well as the pattern indicating the impedance according to the frequency for different spacing values between the strands.

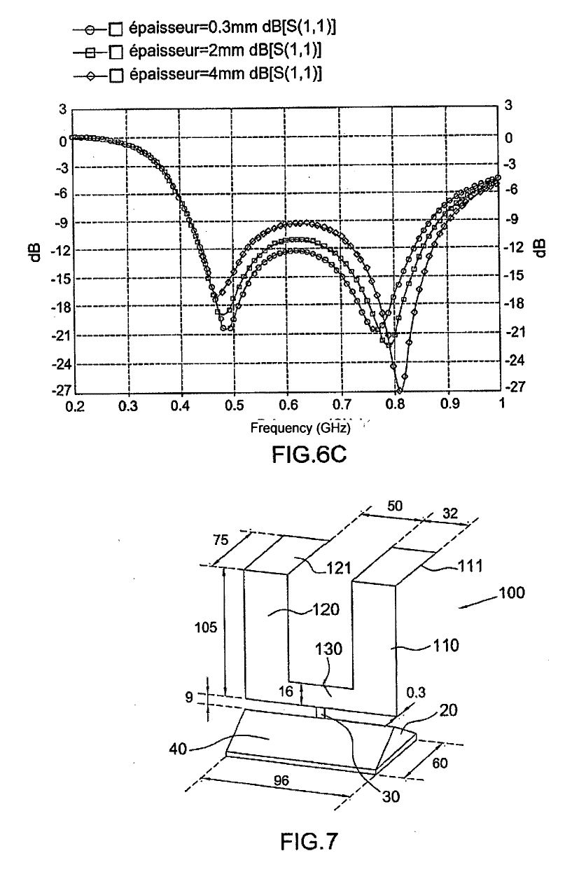

FIGS. 6A, 6B and 6C respectively show an antenna in accordance with the antenna in FIG. 1 but with a different strand thickness as well as a pattern indicating the impedance matching according to the frequency for different strand thicknesses.

FIG. 7 diagrammatically shows another embodiment of an antenna in accordance with the present invention.

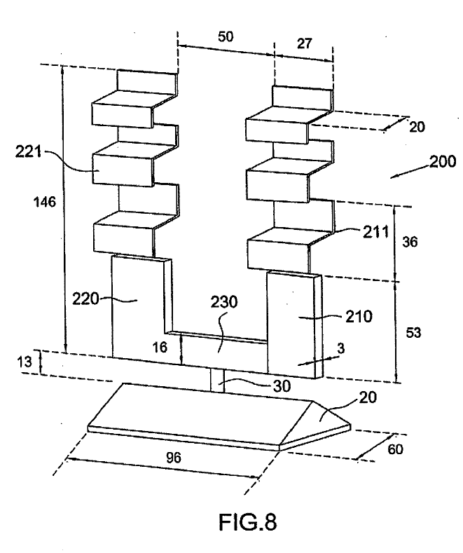

FIG. 8 diagrammatically shows yet another embodiment of an antenna in accordance with the present invention.

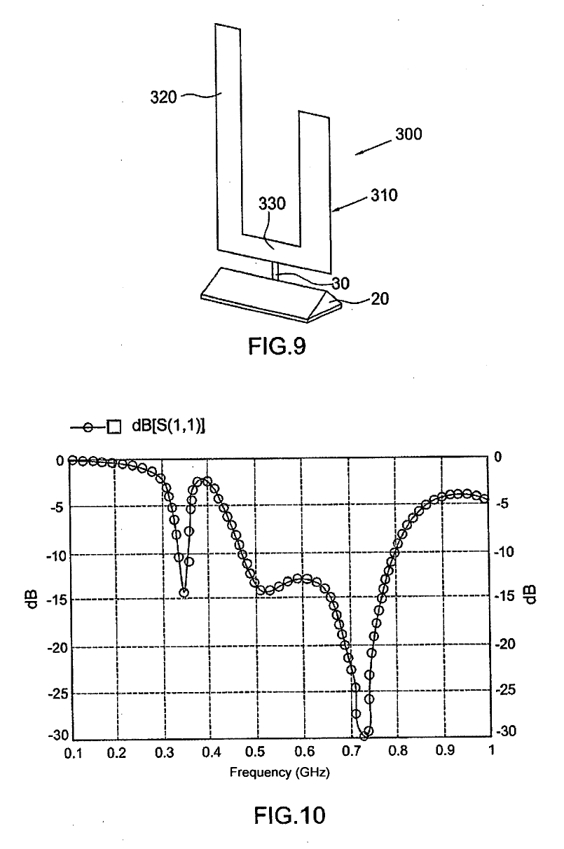

FIG. 9 diagrammatically shows an additional embodiment of an antenna in accordance with the present invention, and

FIG. 10 shows the impedance pattern according to the frequency of the antenna in FIG. 9.

To simplify the description, the same or similar elements have the same references as the figures.

In FIG. 1, a simple embodiment of the present invention is diagrammatically shown. In this embodiment, the monopole antenna is formed by a radiating element 10 comprising two strands 11 and 12 linked to an extremity by an element 13 so as to noticeably form a U. The radiating element 10 is linked by means of a mast 30 which is fixed onto the element 13 to a base 20. The radiating element 10 is connected by means of a connection element such as a coaxial cable 40 or any other means such as a microstrip line or similar, enabling the signal coming from the radiating element to be connected to a similar feed device and without an impedance matching network.

In accordance with the present invention, the two strands 11 and 12 are made from a metal or metallized material and they have a length L such that L is between ¼ λg and ½ λg, λg being the wavelength in the strand at the central radiation frequency F0. Preferably, to obtain a sufficient bandwidth, this length L is in the order of ⅜ λg at the central radiation frequency F0. As this will be explained in more detail later, the dimensioning of the width I of the strand as well as its thickness e enabling the antenna to be impedance matched. On the other hand, the distance p between the two strands 11 and 12 given by the length of element 13 enables the impedance matching of the antenna to be controlled as well as its radiation pattern.

The base 20 is constituted by a metal or metallized plane which serves as the ground plane for radiating element 10 made up of the two strands 11 and 12. The base's shape and dimensions are a control parameter for the impedance matching of the antenna. Preferably, the base has dimensions between ⅕·λg and 1/10·λg where λg is the wavelength at the central radiation frequency F0. As shown in FIG. 1, a mast 30 is mounted in the middle of element 13 and supports the radiating element formed from two strands 11 and 12. The radiating element 10 is connected to a power supply by means of a coaxial cable 40.

An antenna such as the one shown in FIG. 1 was simulated. This antenna has the following dimensions:

Length of the two strands 11 and 12: L=177 mm

Width of strands 11 and 12: I=20 mm

Distance between the two strands: p=50 mm

Height of the mast: H=17 mm

Thickness of strands 11 and 12: e=0.3 mm

Moreover, the base supporting the radiating element has a width of 60 mm and a length of 96 mm. The results of the simulation are given in FIGS. 2 and 3.

FIG. 2 shows the impedance matching S(1.1) according to the frequency. This curve shows that a wideband impedance matching of the U antenna is obtained, that is more than 68% from 439 MHz to 893 MHz for a reflection coefficient of −10 dB.

However for the reception of digital television signals, the antenna must be adapted from 470 MHz to 862 MHz, meaning a necessary relative bandwidth of more than 58%. As the antenna here is impedance matched over more than 68%, it can therefore be used to receive TNT.

FIG. 3 also shows the radiation pattern of the antenna respectively at 450 MHz and at 850 MHz and shows that the antenna of FIG. 1 functions as a monopole type antenna.

The influence of the width of strands 11 and 12 of the antenna on the impedance matching of the said antenna will now be shown with reference to FIGS. 4A, 4B and 4C.

In FIG. 4A, an antenna 10 is shown which is the same type as the antenna in FIG. 1 showing two strands 11 and 12 which have a width I which, in the embodiment, is chosen equal to 37.5 mm, while in FIG. 4B, an antenna 10′ is shown with strands 11′ and 12′ which have a width equal to 7.3 mm.

The antennas such as those in FIGS. 4A and 4B with different strand widths have been simulated and the impedance matching curves are obtained according to the frequency shown in FIG. 4C. From these curves, it is seen that the modification of the width of the vertical strands are used to adjust the impedance matching of the curve S(1,1). Hence, the width of the strands is used to control the impedance matching of the antenna. Preferably, the width of the strands is between 1/10·λg and 1/100·λg, where λg is the length at the central radiation frequency F0.

The influence of the distance p between the two strands is then studied, to know the length of the element 13 linking the two strands 11 and 12 of an antenna 10 as shown in FIGS. 5A and 5B.

FIG. 5A relates to an antenna identical to the one in FIG. 1 with a distance p equal to 20.4 mm

In FIG. 5B, the distance P′ is equal to 110 mm for the antenna 10″. Different distance values have been simulated with spacings varying by steps of 15 mm. The results of the simulation are provided in FIG. 5C, which shows the impedance matching according to the frequency. These curves show that the space between the vertical strands has a very small effect on the central frequency, with a variation of 20 MHz between the extreme cases. However the phase and the bandwidth are modified according to the spacing between the vertical strands 11 and 12. Hence, the distance between strands from centre to centre is preferably between 1/20·λg and ¼·λg, λg being the wavelength at the operating central frequency.

The influence of the thickness e of the vertical strands has also been studied. In FIG. 6A the vertical strands 11 and 12 of antenna 10 show a thickness e equal to 0.3 mm while in FIG. 6B the thickness e′ of the vertical strands 11′″ and 12′″ of the antenna 10′″ is 4 mm. The simulations made for the thicknesses of 0, 3 mm, 2 mm and 4 mm provide an impedance matching according to the frequency represented in FIG. 6C. The variation of thickness also enables the impedance matching of the antenna to be controlled, but it has no significant influence on the radiation patterns. Preferably, the thickness of the strands is between 10 μm and 10 mm.

A description will now be given, with reference to FIGS. 7, 8, 9 of different embodiment variations of an antenna in accordance with the present invention.

In FIG. 7, the radiating element 100 shows two strands with a specific profile, namely a L-shaped profile, with each strand having a vertical part 110, 120 and a horizontal part 111, 121. As for the embodiment in FIG. 1, the two strands are linked one to another by an element 130 so as to have a noticeably U shape. The radiating element 100 is mounted on a base 20 by a mast 30 and it is linked to a feed by a coaxial cable 40. In this case, the length L of the vertical strands 120 and 110 may be reduced in relation to the total length L. It is for example 105 mm with a length for the horizontal part 111 and 121 of the strands equal to 75 mm. An L-shaped profile is therefore used to obtain a more compact antenna. Simulations that are not shown have demonstrated that a U antenna, which has the dimensions given in FIG. 7, namely a strand width of 32 mm, a spacing between strands of 50 mm, a height for the mast of 9 mm and dimensions for the base identical to those in FIG. 1 has enabled a relative bandwidth in the order of 69% to be obtained.

In FIG. 8, another embodiment of an antenna in accordance with the present invention is shown. In this case, the radiating element 200 shows two strands linked by an element 230 connected through a mast 30 to a base 20. Each strand shows a rectilinear part 210, 220 followed by a crenelated part 211, 221. The crenelations 211, 221 have a length of 36 mm and a depth of 20 mm in the embodiment shown in FIG. 8 the rectangular part 210, 220 having a length of 53 mm. The entire width is 146 mm. Simulations of this type of antenna give a relative bandwidth in the order of 66%. In both cases, the associated radiation pattern corresponds to that of a monopole type antenna, the antenna having an L-shaped profile and with an oblique polarization particularly interesting for receiving any type of terrestrial digital television signals emitted with horizontal or vertical polarization.

In FIG. 9, another embodiment of an antenna in accordance with the present invention is shown. In this case, the radiating element 300 comprises two strands 310 and 320 linked by an element 330 connected to a base 20 through a mast 30. In this specific embodiment, the two strands 310 and 320 have different lengths L. An antenna of this type has been simulated.

FIG. 10 provides the Impedance matching curve S(1,1) according to the frequency for such an antenna. It is noticed that with this type of antenna, a second impedance matching band is obtained, namely a first band around 0.35 GHz and a second band around 0.6 GHz (if the central frequency for an impedance matching level of −10 dB is considered). This second impedance matching band results from the introduction of a resonant mode between the two strands. This type of antenna is interesting for WiFi applications in which the antenna must cover the frequency bands around 2.4 GHz and 5 GHz.

1. Monopole antenna comprising a radiating element mounted on a base by means of a mast, the radiating element being formed from two conductive strands in U, wherein the length L of each strand is chosen such that ¼ λg≦L≦½λg, λg being the wavelength in a strand at the central radiation frequency F0.

2. Antenna according to claim 1, wherein each strand has a length L such that L=⅜ λg.

3. Antenna according to claim 1, wherein the two strands have different lengths.

4. Antenna according to claim 1, wherein each strand has a profile corresponding to a specific folding.

5. Antenna according to claim 4, wherein the profile of the folding is an L-shaped, crenellate, polygonal, sinusoidal profile.

6. Antenna according to claim 1, wherein the conductive strands are made from metal or metallized material.

7. Antenna according to claim 1, wherein the base comprises a metal or a metallized material plane forming a ground plane for the radiating element.

8. Antenna according to claim 7, wherein the ground plane has dimensions between ⅕·λg and 1/10·λg, λg being the wavelength in a strand at the central radiation frequency F0.
